(19) United States
(12) Patent Application Publication
(10) Pub. No.: US 2025/0297908 A1
(43) Pub. Date: Sep. 25, 2025

(54) PRESSURE SENSOR

(71) Applicant: WUHAN FINEMEMS INC., Wuhan (CN)

(72) Inventors: Xiaoping WANG, Wuhan (CN); Dengfeng WU, Wuhan (CN); Fanliang LI, Wuhan (CN); Bing LI, Wuhan (CN); Tao SHI, Wuhan (CN); Wan CAO, Wuhan (CN)

(73) Assignee: WUHAN FINEMEMS INC., Wuhan (CN)

(21) Appl. No.: 19/233,275

(22) Filed: Jun. 10, 2025

Related U.S. Application Data
(63) Continuation of application No. PCT/CN2023/089930, filed on Apr. 21, 2023.

(30) Foreign Application Priority Data
Dec. 13, 2022 (CN) 202211592992.2

(51) Int. Cl. G01L 9/04; G01L 9/00; G01L 19/14

(52) U.S. Cl. CPC G01L 9/04; G01L 9/0051; G01L 19/143; G01L 19/144

(57) ABSTRACT

A pressure sensor includes a pressure port provided with a pressure channel extending longitudinally; a pressure sensitive head, wherein a longitudinal distal end of the pressure sensitive head is recessed inward to form a connection cylinder provided with a sensing cavity, and a longitudinal proximal end of the pressure sensitive head correspondingly formed with an elastic diaphragm; a terminal connector and a housing enclosed with the pressure port to form a mounting cavity; a mounting seat and a signal assembly provided in the mounting cavity; and a plurality of electrical connectors electrically connected to the signal assembly after passing through the terminal connector. One side surface of a longitudinal proximal end of the elastic diaphragm is provided with a pressure measurement circuit, and a proximal end of the connection cylinder is sealedly connected to the pressure port.

### CROSS-REFERENCE TO RELATED APPLICATIONS

The present application is a continuation of International Application No. PCT/CN2023/089930, filed on Apr. 21, 2023, which claims priority to Chinese Patent Application No. 202211592992.2, filed on Dec. 13, 2022. The disclosures of the above-mentioned application are incorporated herein by reference in their entireties.

### TECHNICAL FIELD

The present application relates to the technical field of sensors, and in particular to a pressure sensor.

### BACKGROUND

The pressure sensor using a pressure sensitive head introduces the pressure fluid on one side of the metal diaphragm, and sets the Wheatstone bridge composed of the strain gauge or the thick film pressure-sensitive resistors on the other side surface of the metal diaphragm to measure the pressure.

In Chinese Application Publication CN115406565A, the pressure diaphragm and the support member are easily in contact, resulting in measurement result deviation.

The statements in this section only provide background information related to the present application and may not constitute prior art.

### SUMMARY

The present application provides a pressure measurement component and a pressure sensor to isolate the elastic diaphragm of the pressure sensitive head from other components to avoid measurement deviation.

To achieve the above purpose, the present application provides a pressure sensor, including:
a pressure port provided with a pressure channel extending longitudinally;
a pressure sensitive head, a longitudinal distal end of the pressure sensitive head is recessed inward to form a connection cylinder provided with a sensing cavity, and a longitudinal proximal end of the pressure sensitive head correspondingly formed with an elastic diaphragm;
a terminal connector and a housing enclosed with the pressure port to form a mounting cavity;
a mounting seat and a signal assembly provided in the mounting cavity; and
a plurality of electrical connectors electrically connected to the signal assembly after passing through the terminal connector;
one side surface of a longitudinal proximal end of the elastic diaphragm is provided with a pressure measurement circuit, and a proximal end of the connection cylinder is sealedly connected to the pressure port so that a proximal end of the pressure channel is communicated with the sensing cavity;
an outer periphery of a distal end of the pressure port is configured to protrude outward and pass over a periphery of the pressure sensitive head to form a mounting flange;
the signal assembly is provided at the mounting seat and electrically connected to the pressure measurement circuit;
the mounting seat is provided with a compression cylinder, and a distal end of the compression cylinder is abutted against the pressure port; and
the mounting flange is supported at an inner wall of the compression cylinder in the transverse plane, and a gap is formed between the periphery of the pressure sensitive head and the compression cylinder.

In an embodiment, the housing includes a cylindrical shell extending longitudinally and a circle of crimping edges formed by vertically contracting a longitudinal proximal end of the cylindrical shell towards an inner side; and
a distal end of the cylindrical shell is sealedly connected to the pressure port, and the crimping edges are pressed against a periphery of the terminal connector towards the distal end to press the terminal connector and the mounting seat against the pressure port.

In an embodiment, a longitudinal proximal end of the pressure port and a portion thereof close to the proximal end are respectively protruded outwardly to form a flange and a support connection ring;
the connection cylinder is sleeved at the flange, and is supported and welded to the support connection ring; and
the flange, the support connection ring and the connection cylinder are enclosed to form an annular cavity.

In an embodiment, a distal end of a metal seat is configured to protrude outward to form a circle of protrusions.

In an embodiment, the signal assembly includes a transverse plate, a first flexible plate, a longitudinal plate, a second flexible plate and a first conductive connection portion connected in sequence, and the transverse plate, the longitudinal plate and the first conductive connection portion are provided in sequence from near to far; and
the first conductive connection portion is electrically connected to the pressure measurement circuit.

In an embodiment, a second conductive connection portion is provided on one side of the second flexible plate, and the second conductive connection portion is electrically connected to the metal housing or the pressure port through a grounding path embedded in the mounting seat and is grounded.

In an embodiment, the mounting seat is configured to extend longitudinally and one side of the mounting seat is recessed inward to form an accommodation groove for accommodating the longitudinal plate, and a proximal end and a distal end of the accommodation groove relatively form a top plate and a semicircular bottom plate;
the transverse plate is supported and fixed at a proximal end surface of the top plate;
the bottom plate is partially blocked at a proximal end of the compression cylinder; and
the distal end of the compression cylinder is abutted against a support step formed at the pressure port.

In an embodiment, a third conductive connection portion is provided at one side of the transverse plate, and the third conductive connection portion is grounded through the housing.

In an embodiment, at least one first buckle connected to the longitudinal plate is provided on each of the lateral sides of the accommodation groove.

In an embodiment, a relief notch extending to a bottom plate and configured for the second flexible plate to pass through is provided on one side of the bottom plate; and
a second flexible plate layout groove laterally communicated with the relief notch is provided at a proximal end side of the bottom plate.

In an embodiment, the mounting seat is configured to extend longitudinally and one side of the mounting seat is recessed inwardly to form an accommodation groove for accommodating the longitudinal plate, a disassembly hole extending in a direction parallel to the second flexible plate layout groove is provided at a side wall of the compression cylinder, and the disassembly hole is configured to extend to a bottom of the accommodation groove.

In an embodiment, a first flexible plate layout groove extending longitudinally is provided at an edge of the top plate, and a distal end side of the first flexible plate layout groove is communicated with the accommodation groove, and the first flexible plate layout groove and the relief notch are located at a same position in the circumferential direction of the mounting seat; and
the mounting seat is configured to protrude towards the proximal end to form a guide pillar, and one end of the guide pillar towards the proximal end is configured to pass through a first guide hole opened at the transverse plate.

In an embodiment, a surface of a proximal end of the transverse plate is provided with a plurality of fourth conductive connection portions; and
the electrical connector is an elastic member, and a distal end of the electrical connector is electrically contacted with the fourth conductive connection portion after passing through the terminal connector and an end plate.

In an embodiment, the electrical connector is a conductive spring provided with two sections with different outer diameters, and a conical transition section is formed between the two sections of the conductive spring; and
a retention cavity for accommodating the conductive spring is correspondingly formed at the terminal connector, the retention cavity is provided with a compression portion, and the compression portion is configured to press the transition section against the fourth conductive connection portion towards the distal end.

In an embodiment, the distal end of the pressure port is provided with a connection tube connected to a container or a pipe to be measured.

In an embodiment, a side of the pressure port is provided with a concave or straight circumferential position portion.

In an embodiment, the proximal end of the connection cylinder is welded to the pressure port.

In an embodiment, an inner diameter of the proximal end of the pressure channel is configured to gradually expand to form a bell mouth.

In an embodiment, the pressure channel is a stepped hole with an aperture of the pressure channel increasing from near to far.

In an embodiment, the longitudinal proximal end of the pressure port and a portion thereof close to the proximal end respectively protrude laterally outward to form the flange and the support connection ring, the distal end of the compression cylinder is abutted against a support step formed at the pressure port, and a stress isolation groove is formed between the support step and the support connection ring.

The pressure measurement component of the present application can isolate the elastic diaphragm of the pressure sensitive head from other components to avoid measurement deviation.

### BRIEF DESCRIPTION OF THE DRAWINGS

FIG. 1 is a front view of a pressure sensor according to an embodiment of the present application.

FIG. 2 is a cross-sectional view of the pressure sensor along line A-A shown in FIG. 1 according to an embodiment of the present application.

FIG. 3 is a perspective view of the pressure sensor with a housing hidden according to an embodiment of the present application.

FIG. 4 is a perspective cross-sectional view of a partial structure of the pressure sensor along line A-A shown in FIG. 1 according to an embodiment of the present application.

FIG. 5 is a perspective view of a signal assembly according to an embodiment of the present application.

### DETAILED DESCRIPTION OF THE EMBODIMENTS

The technical solution of the present application will be described clearly and completely below with reference to the accompanying drawings. The following embodiments are exemplary and are only intended to explain the present application, and cannot be interpreted as limiting the present application. In the following description, the same mark is used to represent the same or equivalent elements, and repeated descriptions are omitted.

In the description of the present application, it should be understood that the orientation or position relationship indicated by the terms “upper”, “lower”, “inner”, “outer”, “left”, “right”, etc. is based on the orientation or position relationship shown in the accompanying drawings, or the orientation or position relationship in which the product is usually placed when used, or the orientation or position relationship commonly understood by those skilled in the art, which is only for the convenience of describing the present application and simplifying the description, rather than indicating or implying that the equipment or elements referred to must have a specific orientation, be constructed and operated in a specific orientation, and therefore cannot be understood as limiting the present application.

In addition, the terms “installed”, “connected”, and “communicated” should be understood in a broad sense, for example, it can be a fixed connection, a detachable connection, or an integral connection; it can be a mechanical connection or an electrical connection; it can be directly connected, or indirectly connected through an intermediate medium, or it can be the internal connection of two elements. For those skilled in the art, the specific meanings of the above terms in the present application can be understood according to specific circumstances.

It should also be further understood that the term “and/or” used in the specification of the present application and the corresponding claims refers to any combination of one or more of the listed items and all possible combinations.

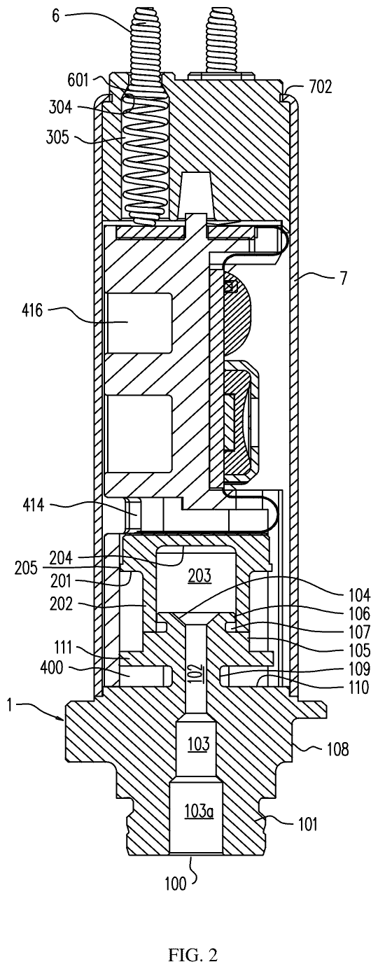

As shown in FIG. 2, the pressure sensor of this embodiment uses such a pressure measurement component, which includes a pressure port 1 and a pressure sensitive head 2. A pressure channel 100 extending longitudinally (i.e., the up and down direction in the figure) is provided in the pressure port 1. The longitudinal distal end (i.e., the bottom in the figure) side of the pressure sensitive head 2 is recessed inward to form a connection cylinder 202 having a sensing cavity 203 towards the distal end, and the longitudinal proximal end side of the pressure sensitive head 2 is correspondingly formed with an elastic diaphragm 204. The longitudinal proximal end side of the elastic diaphragm 204 is provided with a pressure measurement circuit. The proximal end of the connection cylinder 202 is sealedly connected to the pressure port 1 so that the proximal end of the pressure channel 100 is connected to the sensing cavity 203. The distal end of the pressure port 1 is provided with a connection tube 101 connected to the container or pipeline to be measured. The side of the pressure port 1 can be provided with a concave or straight circumferential position portion 108 to facilitate circumferential positioning with the pipeline or container to be measured. The pressure measurement circuit is composed of a thick film varistor.

The proximal end of the connection cylinder 202 is welded to the pressure port 1 (for example, laser welding). The pressure measurement component of this embodiment realizes partial isolation of the assembly stress of the pressure port during installation by setting the pressure port 1 and the pressure sensitive head 2 as a split structure and connecting them into one by welding.

In an embodiment, the longitudinal proximal end of the pressure port 1 protrudes outwardly to form a flange 106, and the portion of the pressure port 1 near the proximal end protrudes outwardly to form a support connection ring 105. The connection cylinder 202 is fitted on the flange 106 and supported and welded on the support connection ring 105. The flange 106, the support connection ring 105 and the connection cylinder 202 are enclosed to form an annular cavity 107.

In this way, the collapsed welding slag can be concentratedly accommodated by the annular cavity during welding, thereby preventing the welding slag from blocking the pressure channel.

In order to facilitate the liquid to flow out of the sensing cavity when measuring the pressure of the liquid, the inner diameter of the proximal end of the pressure channel 100 can be gradually expanded to form a bell mouth 104. In the above-mentioned embodiments, the pressure channel 100 may be a stepped hole with increasing apertures from proximal to distal, for example, it may be formed by connecting a small-diameter section 102 on the proximal end side and a large-diameter section 103 on the distal end side, so that the pressure fluid can easily enter the sensing cavity 203. In an embodiment, the pressure channel 100 further includes a large-diameter section 103a connected to the distal end side of the large-diameter section 103.

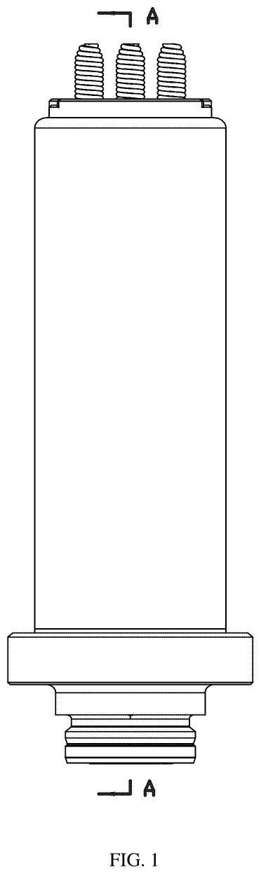

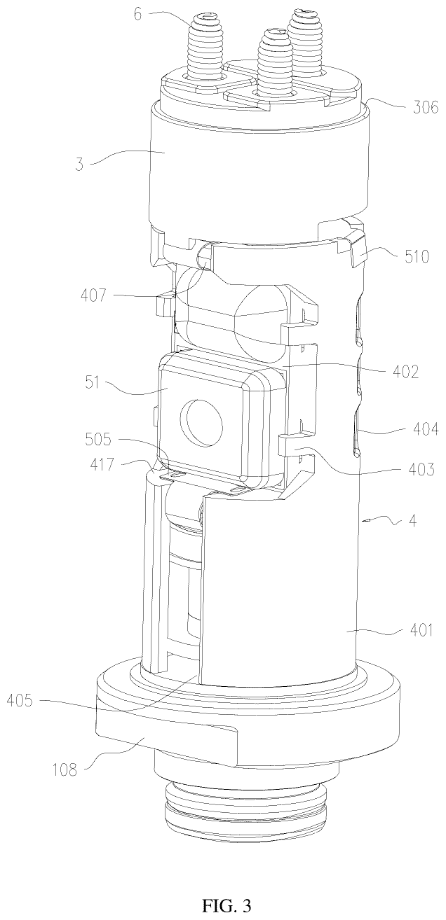

Referring to FIG. 1 to FIG. 4, in an embodiment of the present application, the pressure sensor includes, in addition to the above-mentioned pressure measurement component, a housing 7, a terminal connector 3, a mounting seat 4 and a signal assembly 5. The housing 7 includes a cylindrical shell extending longitudinally and a circle of crimping edges 702 formed by vertically contracting the longitudinal proximal end of the cylindrical shell towards the inner side. The distal end of the cylindrical shell is sealedly connected to the pressure port 1. One distal end of the crimping edge 702 is pressed against the pressure-bearing zone 306 (e.g., a step surface) formed by the periphery of the terminal connector 3, thereby pressing the terminal connector 3 and the mounting seat 4 against the pressure port 1 in sequence.

The terminal connector 3, the housing 7 and the pressure port 1 are enclosed to form a mounting cavity 400. Both the mounting seat 4 and the signal assembly 5 are provided in the mounting cavity 400. The signal assembly 5 is provided on the mounting seat 4 and electrically connected to the pressure measurement circuit. The signals from the signal assembly 5 are outputted to the outside through a plurality of electrical connectors 6, and one end of the electrical connector 6 is electrically connected to the signal assembly 5 after passing through the terminal connector 3 towards the distal end. The signal assembly 5 may include a transverse plate 502, a first flexible plate 503, a longitudinal plate 501, a second flexible plate 504 and a first conductive connection portion 506 connected in sequence, and the transverse plate 502, the longitudinal plate 501 and the first conductive connection portion 506 are provided in sequence from near to far. The first conductive connection portion 506 and the pressure measurement circuit may be electrically connected by soldering. Electronic components (such as a conditioning element 511b and other electronic elements 511a) may be provided on the longitudinal plate 501. In this way, on the one hand, the lateral size of the pressure sensor can be controlled to be very small, so that it can be easily applied to some relatively small spaces (such as some sensor centralized installation modules on cars); at the same time, the measurement circuit that must be provided horizontally can be well and conveniently connected to the longitudinal plate 501, thereby avoiding the difficulties in the existing bonding connection process. These difficulties lie in that the two ends of the aluminum wire or gold wire in the bonding process should be parallel and the drop should be controlled within 1 mm, otherwise it can only be bonded using specially customized equipment. Especially when the surfaces of the two connection points are vertical or even non-parallel, it is difficult to complete the bonding efficiently and accurately even using the specially customized equipment. The first protective sealant 512a can be covered on the other electronic element 511a, and the second protective sealant 512b can be covered on the conditioning element 511b to protect the electronic components. The first protective sealant 512a and/or the second protective sealant 512b can be surrounded by a frame 513 to prevent the protective sealant from contaminating other parts of the longitudinal plate 501, and the frame 513 is provided with a sealant injection hole.

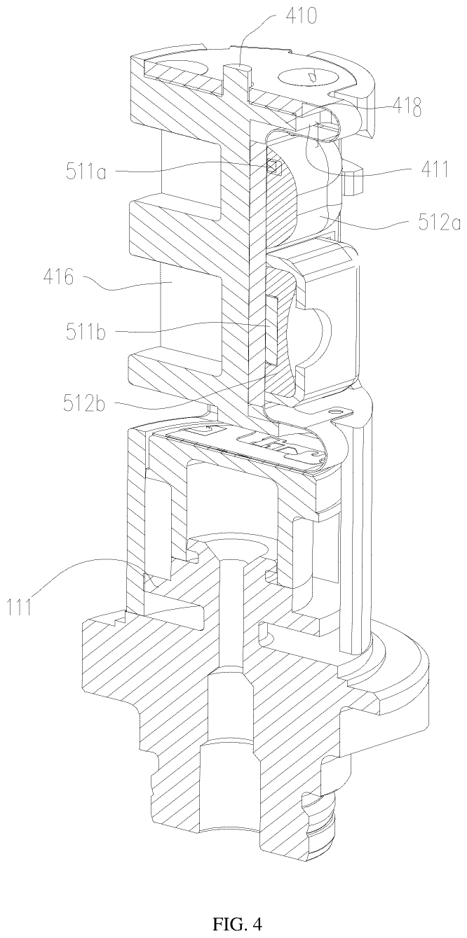

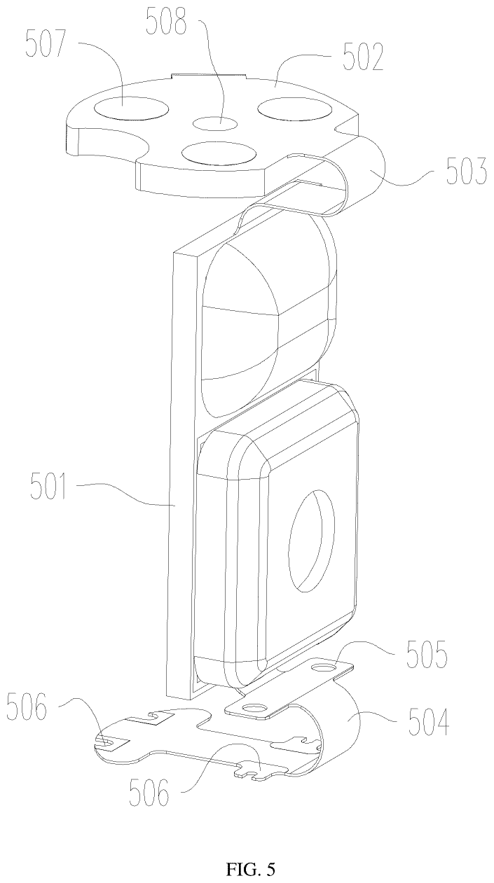

Referring to FIG. 4 and FIG. 5, in order to reliably install the signal assembly 5, the mounting seat 4 is longitudinally extended and the side of the mounting seat 4 is recessed inward to form an accommodation groove 402 for accommodating the longitudinal plate 501, and the proximal end and the distal end of the mounting seat 4 relatively form the top plate 418 and a semicircular bottom plate 417. The transverse plate 502 is supported and fixed at the proximal end surface of the top plate 418. The bottom plate 417 is partially blocked at a proximal end of the compression cylinder 401. The distal end of the compression cylinder 401 is abutted against a support step 110 formed on the pressure port 1. A stress isolation groove 109 is formed between the support step 110 and the support connection ring 105 to further isolate the installation stress of the pressure port 1. At least one first buckle 403 connected to the longitudinal plate 501 is provided on each of the lateral sides of the accommodation groove 402, thereby avoiding the use of the glue bonding process widely used in the prior art and improving production efficiency. A disassembly hole 404 extending in a parallel direction to the second flexible plate layout groove 407 can be provided on the side wall of the compression cylinder 401, and the disassembly hole 404 is extended to the bottom of the accommodation groove 402 to facilitate the disassembly of the longitudinal plate 501 in the accommodation groove 402. A relief notch 405 extending to the bottom plate 417 for the second flexible plate 504 to pass through is provided on the side of the bottom plate 417. A second flexible plate layout groove 407 communicated with the relief notch 405 is provided at the proximal end side of the bottom plate 417. A plurality of second lightening blind holes 416 can be provided on the side of the mounting seat 4 facing away from the accommodation groove 402.

An edge of the top plate 418 is provided with a first flexible plate layout groove 411 extending longitudinally and communicated with the accommodation groove 402 towards the distal end. The first flexible plate layout groove 411 and the relief notch 405 are located at the same position in the circumferential direction of the mounting seat 4.

In an embodiment, the distal end periphery of the support connection ring 105 may protrude outward and pass over the periphery of the metal seat 201 to form an mounting flange 111, and the mounting flange 111 may be supported against the inner wall of the compression cylinder 401 in the transverse plane. A gap is formed between the periphery of the metal seat 201 and the compression cylinder 401. In this way, the mounting flange 111 and the mounting seat 4 can be installed and positioned, and the mounting seat 4 can be prevented from contacting the metal seat 201 to cause a deviation in the measurement result.

In an embodiment, the distal end of the metal seat 201 protrudes outward to form a circle of protrusions 205, and the protrusions 205 preferably are in a stepped surface. In this way, the stepped surface on the outer wall can further alleviate the axial transmission of the installation stress between the connection cylinder 202 and the support connection ring 105 to the elastic diaphragm 204, thereby reducing the measurement error.

The compression cylinder 401 and the pressure sensitive head 2 can be provided with positioning structures correspondingly, for example, the mounting flange 111 can be formed with a straight edge, a groove or a convex ridge, and the compression cylinder 401 can be provided with the straight edge, the convex ridge or the groove correspondingly. In this way, the mounting seat 4 and the pressure sensitive head 2 can be conveniently positioned circumferentially.

The proximal end surface of the transverse plate 502 is provided with a plurality of fourth conductive connection portions 507. The electrical connector 6 is an elastic member, such as a conductive spring, and the distal end of the electrical connector 6 can be inserted through the terminal connector 3 and pressed against and electrically contacted with the fourth conductive connection portion 507. In an embodiment, the electrical connector 6 is a conductive spring having two sections with different outer diameters of coils, and a tapered transition section 601 is formed between the two sections. A retention cavity 305 for accommodating the conductive spring 6 is formed at the terminal connector 3, the retention cavity 305 is provided with a compression portion 304, and the compression portion 304 presses the transition section 601 against the fourth conductive connection portion 507 towards the distal end side. In order to accurately position the terminal connector 3 and the mounting seat 4, positioning structures are correspondingly provided at the terminal connector 3 and the mounting seat 4. For example, the mounting seat 4 can protrude towards the proximal end to form a guide pillar 410, and a first guide hole is correspondingly provided at the terminal connector 3; alternatively or additionally, the periphery of the terminal connector 3 or the mounting seat 4 can protrude towards the mounting seat 4 or the terminal connector 3 to form at least one guide foot, and the guide foot is inserted into a guide groove correspondingly provided at the mounting seat 4 or the terminal connector 3. The distal end of the terminal connector 3 is provided with an avoidance blind hole (not marked) for allowing the guide pillar 410 to extend thereinto.

In an embodiment, the mounting seat 4 protrudes towards the proximal end side to form the guide pillar 410. The guide pillar 410 is cooperatively inserted into a second guide hole 508 opened at the transverse plate 502. An operation port 414 is opened on the side wall of the mounting seat 4 opposite to the relief notch 405 to allow operation space for soldering.

In an embodiment, a third conductive connection portion 510 is provided at the side of the transverse plate 502. A second conductive connection portion 505 is provided at the side of the second flexible plate 504. The second conductive connection portion 505 is electrically connected to the metal housing 7 or the pressure port 1 through the grounding path embedded in the mounting seat 4 and is grounded. The third conductive connection portion 510 can be grounded via the housing 7.

The scope of the present application is defined not by the detailed description but by the claims and their equivalents, and all variations within the scope of the claims and their equivalents are construed as being included in the present application.

What is claimed is:

1. A pressure sensor, comprising:
a pressure port provided with a pressure channel extending longitudinally;
a pressure sensitive head, wherein a longitudinal distal end of the pressure sensitive head is recessed inward to form a connection cylinder provided with a sensing cavity, and a longitudinal proximal end of the pressure sensitive head correspondingly formed with an elastic diaphragm;
a terminal connector and a housing enclosed with the pressure port to form a mounting cavity;
a mounting seat and a signal assembly provided in the mounting cavity; and
a plurality of electrical connectors electrically connected to the signal assembly after passing through the terminal connector;
wherein one side surface of a longitudinal proximal end of the elastic diaphragm is provided with a pressure measurement circuit, and a proximal end of the connection cylinder is sealedly connected to the pressure port so that a proximal end of the pressure channel is communicated with the sensing cavity;
an outer periphery of a distal end of the support connection ring is configured to protrude outward and pass over a periphery of the metal seat to form a mounting flange;
the signal assembly is provided at the mounting seat and electrically connected to the pressure measurement circuit;
the mounting seat is provided with a compression cylinder, and a distal end of the compression cylinder is abutted against the pressure port; and
the mounting flange is supported at an inner wall of the compression cylinder in the transverse plane, and a gap is formed between the periphery of the pressure sensitive head and the compression cylinder.

2. The pressure sensor according to claim 1, wherein:
the housing comprises a cylindrical shell extending longitudinally and a circle of crimping edges formed by vertically contracting a longitudinal proximal end of the cylindrical shell towards an inner side; and
a distal end of the cylindrical shell is sealedly connected to the pressure port, and the crimping edges are pressed against a periphery of the terminal connector towards the distal end to press the terminal connector and the mounting seat against the pressure port.

3. The pressure sensor according to claim 1, wherein:
a longitudinal proximal end of the pressure port and a portion thereof close to the proximal end are respectively protruded outwardly to form a flange and a support connection ring;
the connection cylinder is sleeved at the flange, and is supported and welded to the support connection ring; and
the flange, the support connection ring and the connection cylinder are enclosed to form an annular cavity.

4. The pressure sensor according to claim 1, wherein a distal end of a metal seat is configured to protrude outward to form a circle of protrusions.

5. The pressure sensor according to claim 1, wherein the signal assembly comprises a transverse plate, a first flexible plate, a longitudinal plate, a second flexible plate and a first conductive connection portion connected in sequence, and the transverse plate, the longitudinal plate and the first conductive connection portion are provided in sequence from near to far; and
the first conductive connection portion is electrically connected to the pressure measurement circuit.

6. The pressure sensor according to claim 5, wherein a second conductive connection portion is provided on one side of the second flexible plate, and the second conductive connection portion is electrically connected to the metal housing or the pressure port through a grounding path embedded in the mounting seat and is grounded.

7. The pressure sensor according to claim 5, wherein:
the mounting seat is configured to extend longitudinally and one side of the mounting seat is recessed inward to form an accommodation groove for accommodating the longitudinal plate, and a proximal end and a distal end of the accommodation groove relatively form a top plate and a semicircular bottom plate;
the transverse plate is supported and fixed at a proximal end surface of the top plate;
the bottom plate is partially blocked at a proximal end of the compression cylinder; and
the distal end of the compression cylinder is pressed against a support step formed at the pressure port.

8. The pressure sensor according to claim 7, wherein a third conductive connection portion is provided at one side of the transverse plate, and the third conductive connection portion is grounded through the housing.

9. The pressure sensor according to claim 5, wherein at least one first buckle connected to the longitudinal plate is provided on each of the lateral sides of the accommodation groove.

10. The pressure sensor according to claim 5, wherein:
a relief notch extending to a bottom plate and configured for the second flexible plate to pass through is provided on one side of the bottom plate; and
a second flexible plate layout groove laterally communicated with the relief notch is provided at a proximal end side of the bottom plate.

11. The pressure sensor according to claim 10, wherein the mounting seat is configured to extend longitudinally and one side of the mounting seat is recessed inwardly to form an accommodation groove for accommodating the longitudinal plate, a disassembly hole extending in a direction parallel to the second flexible plate layout groove is provided at a side wall of the compression cylinder, and the disassembly hole is configured to extend to a bottom of the accommodation groove.

12. The pressure sensor according to claim 5, wherein:
a first flexible plate layout groove extending longitudinally is provided at an edge of the top plate, and a distal end side of the first flexible plate layout groove is communicated with the accommodation groove, and the first flexible plate layout groove and the relief notch are located at a same position in the circumferential direction of the mounting seat; and
the mounting seat is configured to protrude towards the proximal end to form a guide pillar, and one end of the guide pillar towards the proximal end is configured to pass through a first guide hole opened at the transverse plate.

13. The pressure sensor according to claim 5, wherein:
a surface of a proximal end of the transverse plate is provided with a plurality of fourth conductive connection portions; and
the electrical connector is an elastic member, and a distal end of the electrical connector is electrically contacted with the fourth conductive connection portion after passing through the terminal connector and an end plate.

14. The pressure sensor according to claim 13, wherein:
the electrical connector is a conductive spring provided with two sections with different outer diameters, and a conical transition section is formed between the two sections of the conductive spring; and
a retention cavity for accommodating the conductive spring is correspondingly formed at the terminal connector, the retention cavity is provided with a compression portion, and the compression portion is configured to press the transition section against the fourth conductive connection portion towards the distal end.

15. The pressure sensor according to claim 1, wherein the distal end of the pressure port is provided with a connection tube connected to a container or a pipe to be measured.

16. The pressure sensor according to claim 1, wherein a side of the pressure port is provided with a concave or straight circumferential position portion.

17. The pressure sensor according to claim 1, wherein the proximal end of the connection cylinder is welded to the pressure port.

18. The pressure sensor according to claim 1, wherein an inner diameter of the proximal end of the pressure channel is configured to gradually expand to form a bell mouth.

19. The pressure sensor according to claim 1, wherein the pressure channel is a stepped hole with an aperture of the pressure channel increasing from near to far.

20. The pressure sensor according to claim 1, wherein the longitudinal proximal end of the pressure port and a portion thereof close to the proximal end respectively protrude laterally outward to form the flange and the support connection ring, the distal end of the compression cylinder is pressed against a support step formed at the pressure port, and a stress isolation groove is formed between the support step and the support connection ring.
